(19) United States
(12) Patent Application Publication
(10) Pub. No.: US 2008/0256647 A1
(43) Pub. Date: Oct. 16, 2008

(54) System and Method For Tracing Illegally Copied Contents on the Basis of Fingerprint

(75) Inventors: Jin Ho Kim, Taejon (KR); Wonyoung Yoo, Taejon (KR); Yong Seok Seo, Taejon (KR); Seon Hwa Lee, Taejon (KR); Young Ho Suh, Taejon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTIT, Taejon (KR)

(21) Appl. No.: 11/575,884

(22) PCT Filed: Nov. 24, 2004
(86) PCT No.: PCT/KR04/03035

§ 371 Date: Mar. 23, 2007

(30) Foreign Application Priority Data
Oct. 13, 2004 (KR) 10-2004-0081888

(51) Int. Cl. G06F 21/00

(52) U.S. Cl. 726/32

(57) ABSTRACT

Disclosed is a system and method for tracing illegally copied contents on the basis of fingerprint. Purchaser information is inserted into digital contents that include image, audio or video data using a fingerprinting system when the digital contents are sold in the distribution process of the digital contents. If the contents purchaser has illegally copied and distributed the contents through the Internet or a P2P (Peer to Peer) server that is a file sharing server, the corresponding contents are searched for using a searcher and the corresponding purchaser is traced on the basis of fingerprint information inserted into the contents.

### TECHNICAL FIELD

The present invention relates to a system and method for tracing illegally copied contents on the basis of fingerprint, and more particularly to a system and method for tracing illegally copied contents on the basis of fingerprint which can insert purchaser information into digital contents that include image, audio or video data using a fingerprinting system when the digital contents are sold in the distribution process of the digital contents, and search for the corresponding contents using a searcher and trace the corresponding purchaser on the basis of fingerprint information inserted into the contents if the corresponding contents purchaser has illegally copied and distributed the contents through the Internet or a P2P (Peer to Peer) server that is a file sharing server.

### BACKGROUND ART

Digital contents that include image, audio or video data can easily be copied and illegally distributed through the Internet, P2P network, etc. Such an illegal copying of the digital contents has most threatened the enterprises of contents providers who process and sell such digital contents.

In order to prevent the illegal copying of the digital contents, many technologies have been developed. They include a DRM (Digital Rights Management) technology for packaging and encrypting the contents so that the contents are purchased in an authenticated environment, a DPP (Digital Property Protection) technology for preventing the contents from being stored in a hard disk or from being printed, and a watermarking technology for invisibly inserting information about a seller or a copyrighter of the contents into the contents.

Among the above-described technologies, the DRM technology has been used mast generally in order to prevent the illegal copying of the digital contents. The hardware of the DRM includes a DRM server for supporting the sales of the digital contents and clients for supporting the purchase of the digital contents, and serves to perform a purchaser authentication by a license, a management of copyrights and details of purchase approval during the contents purchase, a setting of a use authority and method during the contents purchase, a purchase settlement by a clearing house, a packaging and encrypting of the contents, a permission of the contents superdistribution, etc. In the DRM authentication environment, all the digital contents are packaged and encrypted, and thus they can safely be protected from the illegal copying. That is, since even the digital contents superdistributed among clients are in an encrypted state, it is impossible to illegally use them. For example, a user can receive an authority to use a key for decrypting the code through a legal purchase after he/she performs a purchase authentication procedure by acceding the corresponding DRM server through a client, and then can use the digital contents using the key.

The representative characteristic of the DRM technology is to encrypt the digital contents and transfer the encrypted contents to a purchaser in order to prevent the illegal copying of the contents. Accordingly, in order to use the corresponding contents, the purchaser should receive the key for decrypting the code and a license from the DRM server through the client.

However, the encrypted digital contents are decrypted when the purchaser uses the contents. At this time, by using a tool that can capture image, video or audio data, the image or video contents being displayed on a computer monitor or the sound contents being outputted to a speaker, which are almost the same as the original contents, can be stored. Although DRM companies have used various methods for preventing the contents capture, the prevention of the contents capture is limited because new capture technologies have been developed against the existing capture prevention method. Since it is almost impossible to hack the encryption technology used in the DRM, the capture tool has been used to illegally copy the contents.

The encrypted contents may be hacked by invading a server in which the contents before being encrypted are stored and stealing the stored contents, or by storing the decrypted contents being outputted through a monitor or a speaker using a capture tool.

The procedure of storing the decrypted contents using the capture tool is as follows. For the sake of convenience, it is exemplified that a capture tool of audio contents that can easily be obtained on the Internet is used.

If a legal purchaser purchases the audio contents, he/she can also receive a key for decrypting the code. A contents provider generally provides image, audio or video contents in the form of a compressed file such as JPEG, MP3, MPEG, etc. The reason why the contents are compressed is to store more contents in a limited space of a hard disk by greatly reducing the size of the file in the ratio of one to several tens. Also, the load of the network required for the contents service, for example, the transmission speed and capacity, can be reduced as much as the compression rate. The purchaser can use the contents after he/she decompresses the contents using an audio or video decompression unit, which is called a codec, built in the PC. Since this codec exists outside the authentication area of the DRM, it is difficult to control the codec through the DRM. Thus, the encrypted contents should be decrypted before it is processed by the codec. In this case, by using the capture tool, the decrypted contents, which are entering into the codec, can be captured and stored as a copy. The contents obtained as above are the decrypted compressed contents. Meanwhile, the output of the codec is inputted to an audio or video player to be outputted through a speaker or monitor, and at this time, the contents can also be captured using the capture tool. The contents obtained as above are the decompressed contents.

In the case of capturing the audio contents such as MP3 and so on, the copied audio contents, which are the same as the original contents, can be stored using a proper capture tool just before the decrypted audio contents are inputted to the audio codec. Although the audio contents outputted from the audio codec but just before the input to the speaker have a relatively large file size in comparison to the original compressed contents, they can be converted into an MP3 type file that is the same as the original audio file through a re-compression process using various kinds of compression units for converting the contents into the MP3 file in the form of a compressed audio file. In this case, the converted MP3 file is not the same as the original audio file, but has a similar sound quality to the original audio file.

As described above, it is possible to store the copied audio contents using the capture tool just before the decrypted audio contents are inputted to the audio codec, or to create a file similar to the original file by capturing the audio data outputted from the audio codec but just before the input to the speaker.

The process of capturing the video contents such as MPEG and so on is similar to the process of capturing the audio contents as described above. For example, the user properly purchases the video contents, and receives a key for decrypting the code. The copied video contents, which are the same as the original contents, can be stored using a proper video capture tool just before the decrypted video contents are inputted to the video codec. The video data outputted from the video codec but just before the input to the display screen through the Windows Media Player has a relatively large file size, but it can be converted into an MPEG type file that is the same as the original video file through a re-compression process using various kinds of compression units for converting the video data into the MPEG in the form of a compressed video file. In this case, the converted MPEG file is not the same as the original video file, but has a similar picture quality to the original video file. Since the audio or video data captured as above has an audio or video quality similar to that of the original audio or video data, many persons use the illegally copied contents being distributed on the Internet or P2P server instead of purchasing the corresponding contents.

The present DRM method prevents the illegal copying of the contents by introducing a technique that copes with the known capture tool. Accordingly, it is almost impossible to seize the compressed contents being inputted to the codec on the way. However, the technology of capture tools has also been developed to avoid the illegal copy prevention technology in the DRM.

For example, since it is difficult for the DRM method to prevent the illegal copying of the contents just before the output to the speaker or the monitor, a technology of capturing and re-compressing of the data just before the output to the speaker or the monitor has been developed although the decompressed data has a large file size. This technology is based on the point that even the encrypted contents should be decrypted when the purchaser uses the contents.

The DRM method has the advantage of the contents encryption, but also has the disadvantage that the contents should finally be decrypted when the purchaser uses the contents. Accordingly, it is possible to illegally copy the contents using the capture tool at a vulnerable moment that the contents purchaser decrypts the contents, but the DRM method is not provided with any means for preventing such an illegal copying of the contents.

In order to solve the problems of the above-described DRM method, a watermarking technology that serves to insert copyright information into the contents invisibly and inaudibly has been proposed. Insertion of a watermark is performed through applying of a slight modification to the original contents. In the case of image contents, even if a complicated portion of the image is slightly modified, a human cannot easily recognize the difference between the original image and the modified image in vision. Also, in the case of audio contents, even if a portion where sound is greatly changed is slightly modified, a human cannot easily recognize the difference between the original audio and the modified audio in hearing.

The watermarking technology that serves to slightly modify the original contents and insert the copyright information into the contents is classified into a spatial-domain watermarking for directly manipulating data of the contents and a frequency-domain watermarking for converting the contents data into a frequency domain using DCT (Discrete Cosine Transform) or wavelet transform and modifying coefficient values of the converted domain. Recently, the frequency-domain watermarking method has mainly been used.

Watermark information inserted into the digital contents is not easily removed by compression, signal process, geometrical conversion, etc. For example, even if the decompressed contents are copied and re-compressed by the capture tool, the inserted watermark information endures the compression and still remains in the contents. Accordingly, the copyright holder can extract the watermark from the illegally copied digital contents and use the watermark as evidence of an infringement of his/her copyright. However, the disadvantage of the watermarking method is that the watermark information inserted into the contents is nothing but one of the copyright information. Even if a seller sold digital contents with his/her copyright information inserted into the contents through watermarking and one of many purchasers illegally copied the contents, the seller who has recognized the illegal copying of the contents cannot trace who among many purchasers illegally copied the contents. The copyright holder can only extract the copyright information from the illegally copied contents and asserts his/her copyright accordingly. That is, the watermarking method is of no use for the tracing of the person who illegally copied the contents, and thus is not effective in copyright protection.

Meanwhile, Korean Patent Unexamined Publication No. 2003-0015742 published on Feb. 25, 2003 discloses a “System for tracing illegal copying and illegal distribution of digital contents” as a technology of tracing illegally copied digital contents. According to this technology, a client agent, which is installed in a client's PC as a program for an illegal copy tracing, monitors and traces any user's access of the illegal copy of the contents. This technology has the drawback in that it is required to install the client agent in the user's PC.

Also, Korean Patent Unexamined Publication No. 2003-0051376 discloses a “System for managing digital intellectual property rights on the basis of an adaptive agent and method thereof” as a technology of preventing an illegal copy of digital contents. According to this technology, a management server for performing a storage and management of digital contents authorized by a copyright holder is provided, and a user terminal having an adaptive agent installed therein monitors the illegal copying of the digital contents. Accordingly, this technology requires the installation of the adaptive agent in the user terminal.

In illegally copying rightly sold digital contents, the person who has first made the illegal copy of the contents is guiltiest, and it is general that the person who has first made the illegal copy distributes the copied digital contents to a large number of people through the Internet or P2P server. However, according to the two technologies as described above, it is just monitored whether the illegally copied digital contents exist in the user terminal or whether the illegally copied digital contents are being distributed through the Internet or P2P server. Consequently, the two technologies cannot propose any technical solution to trace the person who has first made the illegal copy of the contents and thus has to be punished most severely.

### DISCLOSURE OF THE INVENTION

Therefore, the present invention has been made to solve the above-mentioned problem occurring in the prior art, and an object of the present invention is to provide a system and method for tracing illegally copied contents on the basis of fingerprint which can trace purchaser information by inserting the converted purchaser information into digital contents on sale as fingerprint data and extracting the fingerprint from the illegally copied digital contents being distributed through the Internet or a P2P server.

Additional advantages, objects, and features of the invention will be set forth in part in the description which follows and in part will become apparent to these having ordinary skill in the art upon examination of the following or may be learned from practice of the invention.

In order to accomplish the above-mentioned objects, a system for tracing illegally copied contents on the basis of fingerprint according to the present invention comprises a client for receiving encrypted contents by transmitting a purchase request for digital contents, receiving a fingerprint by providing purchase information for creating the fingerprint, and inserting the received fingerprint into the encrypted contents; a digital rights management (DRM) server for transmitting the encrypted digital contents to the client according to the purchase request from the client and outputting transaction information related to sales and purchase of the contents; a contents transaction information database (DB) for receiving and storing the contents transaction information from the DRM server, and extracting and outputting seller's own information for creating the fingerprint from the contents transaction information as sales information; a fingerprint creator/manager for creating the fingerprint using the sales information received from the contents transaction information DB and the purchase information received from the client, and transmitting the created fingerprint to the client; a contents searcher for collecting the digital contents by searching various kinds of sites of Internet and peer-to-peer (P2P) servers, extracting the fingerprint from the collected digital contents if the fingerprint has been inserted into the digital contents, and outputting the extracted fingerprint to the fingerprint creator/manager along with searched information of the corresponding digital contents; and an illegal copy judgment unit for receiving transaction information of illegally copied digital contents and information about a possibility of illegal copy permission, and permitting the illegal copying of the purchaser if it is judged that the seller permits the illegal copying of the corresponding contents from the received information while if not, transmitting the seller information and the purchaser information of the corresponding contents to a specified illegal copy report center as evidence of the illegal copy; wherein the fingerprint creator/manager searches for the sales information of the fingerprint using the fingerprint received from the contents searcher, transmits the searched sales information to the contents transaction information DB, and transmits the searched information of the illegally copied contents to the illegal copy judgment unit; and wherein the contents transaction information DB searches for the transaction information of the illegally copied contents from the sales information received from the fingerprint creator/manager, and transmits the information about the possibility of illegal copy permission added to the searched transaction information to the illegal copy judgment unit along with the searched transaction information.

In another aspect of the present invention, there is provided a method for tracing illegally copied contents on the basis of fingerprint, comprises the steps of (a) encrypting digital contents and transmitting the encrypted digital contents to a client according to a contents purchase request of the client, and storing transaction information related to sales and purchase of the contents in a seller's database (DB); (b) receiving transaction information of the sold digital contents and client's own purchase information, and creating the fingerprint; (c) transmitting the fingerprint created at the step (b) to the client to insert the fingerprint into the sold digital contents; (d) collecting the digital contents by searching various kinds of sites of Internet and peer-to-peer (P2P) servers, and extracting the fingerprint from the collected digital contents if the fingerprint has been inserted into the digital contents; (e) searching for transaction information corresponding to the fingerprint extracted at the step (d) from the seller's DB, and searching for information about a possibility of illegal copy permission; and (f) judging whether to punish for the illegal copying on the basis of the transaction information searched at the step (e) and the information about the possibility of illegal copy permission, and if a punishment is necessary, transmitting the searched information of the illegally copied contents and the transaction information to a specified administrative organ.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a block diagram illustrating the whole construction of a system for tracing illegally copied contents on the basis of fingerprint according to an embodiment of the present invention;

FIG. 2 is a block diagram illustrating in detail the construction of a client, a fingerprint creator/manager and a contents searcher as illustrated in FIG. 1;

FIG. 3 is a block diagram illustrating in more detail the construction of a client as illustrated in FIG. 2; and

FIG. 4 is a flowchart illustrating a method for tracing illegally copied contents on the basis of fingerprint according to an embodiment of the present invention.

### BEST MODE FOR CARRYING OUT THE INVENTION

Now, a system and method for tracing illegally copied contents on the basis of fingerprint according to preferred embodiments of the present invention will be described in detail with reference to the annexed drawings.

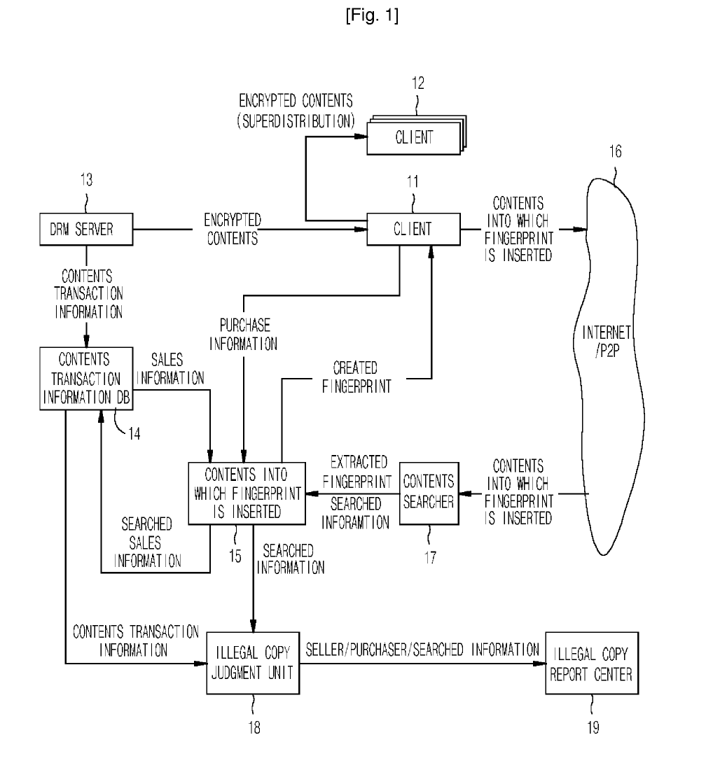

FIG. 1 is a block diagram illustrating the whole construction of a system for tracing illegally copied contents on the basis of fingerprint according to an embodiment of the present invention.

As shown in FIG. 1, the system for tracing illegally copied contents on the basis of fingerprint according to an embodiment of the present invention includes a plurality of clients 11 and 12 that can be connected to the Internet or P2P server 16, a DRM server 13, a contents transaction information DB 14, a fingerprint creator/manager 15, a contents searcher 17 and an illegal copy judgment unit 180. The illegal copy judgment unit 18 can provide seller/purchaser/searched information related to the illegal copying to an illegal copy report center 19.

The clients 11 and 12 transmit a purchase request for the digital contents to the DRM server 13, and the DRM server 13 transmits the encrypted contents to the corresponding clients in response to the purchase request. One client 11 may transmit the encrypted contents to another client 12, or may receive the encrypted contents from another client 12. In order to use the encrypted contents, the respective clients 11 and 12 should receive a key that can decrypt a code by requesting the purchase of the corresponding contents to the DRM server 13. In the DRM environment, this process is called a “superdistribution”, and this superdistribution contributes the promotion of the sales of the contents.

The DRM server 13 transmits the encrypted contents to the corresponding clients according to the purchase request from the clients 11 and 12. Simultaneously, the DRM sever 13 transmits transaction information related to sales and purchase of the contents to the contents transaction information DB 14. The transaction information may be different according to the sales managing type of the contents seller who operates the DRM server 13, and may briefly include a seller's name, a purchaser's name, information about contents use authority, a client's Internet address from which the encrypted contents have been transmitted, a date of sales, an amount of sales, etc.

The contents transaction information DB 14 stores the contents transaction information received from the DRM server 13, extracts seller's own information for the creation of the fingerprint from the contents transaction information as sales information, and transmits the extracted information to the fingerprint creator/manager 15. In making a purchase in an online such as the Internet, the seller should not provide the purchaser and seller information to an outside in order to protect the purchaser's private information. If the fingerprint creator/manager 15 is operated by an outer expert organization in a state that the seller does not possess the fingerprint creator/manager 15, only a part of the contents transaction information required for the creation of the fingerprint should be provided as the sales information so that the fingerprint creator/manager 15 cannot know all the contents transaction information. For example, the sales information transmitted to the fingerprint creator/manager 15, the transaction information corresponding to the sales information and the fingerprint corresponding to the sales information are related to one another.

Meanwhile, in order for the clients 11 and 12 to use the encrypted contents received from the DRM server 13, the contents should be decrypted and the fingerprint should be inserted into the contents. The clients 11 and 12 create and transmit the client's own purchase information to the fingerprint creator/manager 15 for the creation of the fingerprint.

The fingerprint creator/manager 15 receives the sales information from the contents transaction information DB 14 and the purchase information from the clients 11 and 12, and creates the fingerprint using the received sales information and purchase information. The created fingerprint is transmitted to the clients that sent the purchase information along with the sales information and the purchase information as well as it is stored in a DB inside the fingerprint creator/manager 15.

The clients 11 and 12 insert the fingerprint received from the fingerprint creator/manager 15 into the pre-purchased encrypted digital contents. The process of inserting the fingerprint into the digital contents is safely guaranteed by the DRM method, and in order for the purchaser to use the digital contents purchased through the client, this insertion process should be performed. Meanwhile, in the clients 11 and 12, normally purchased digital contents or digital contents superdistributed from another client may illegally be copied using a capture tool, and the digital contents illegally copied as above may be distributed through an Internet site such as P2P site and so on.

The contents searcher 17 collects the digital contents by searching various kinds of Internet sites and P2P servers, and checks whether the fingerprint has been inserted into the collected digital contents. If the fingerprint has been inserted into the corresponding digital contents as a result of checking, the contents searcher 17 extracts the fingerprint from the corresponding digital contents, and transmits the searched information such as an Internet site address, a P2P server address, etc., from which the digital contents are searched for, to the fingerprint creator/manager 15 along with the extracted fingerprint.

The fingerprint creator/manager 15 searches for the sales information of the received fingerprint, which has been stored in its own DB, using the fingerprint received from the contents searcher 17. If the corresponding sales information is found, the fingerprint creator/manager 15 transmits the found sales information to the contents transaction information DB 14.

The contents transaction information DB 14 searches for the transaction information corresponding to the transaction information received from the fingerprint creator/manager 15, and transmits the searched transaction information to the illegal copy judgment unit 18. In this case, even if the corresponding digital contents are the illegally copied digital contents, they may be permitted according to a seller's marketing strategy, and in this case, information indicating that the illegal copying of the corresponding digital contents is possible may be previously added to the contents transaction information by the seller. However, in order to prevent the purchaser's illegal copying of the digital contents, it is possible to send a warning mail and so on to the purchaser. In order to support this function, the contents transaction information DB 14 may transmit information about whether to permit the illegal copying of the contents, which was preset by the seller, to the illegal copy judgment unit 18 along with the searched transaction information.

The illegal copy judgment unit 18 receives the transaction information of the illegally copied digital contents and the information about the possibility of illegal copy permission from the contents transaction information DB. As described above, if the seller permits the illegal copying of the corresponding contents according to the seller's marketing strategy, no sanction is taken against the purchaser of the corresponding contents, i.e., the person who is assumed to have illegally copied the contents. If it is judged that the punishment of the purchaser is required through the information received from the contents transaction information DB, the illegal copy judgment unit 18 transmits the searched information of the corresponding contents, seller and purchaser information, etc., to the illegal copy report center 19 as evidence of the illegal copying. The illegal copy report center 19 traces the purchaser who has illegally copied the corresponding contents by analyzing the evidence, and inflicts proper punishment for the corresponding illegal copying of the contents.

The illegal copy report center 19 does not refer to a direct system construction that belongs to the present invention, but may be administrative organs that exist outside the system according to the present invention such as Cyber Crime Investigation division of the Metropolitan Police Agency or their operating sites.

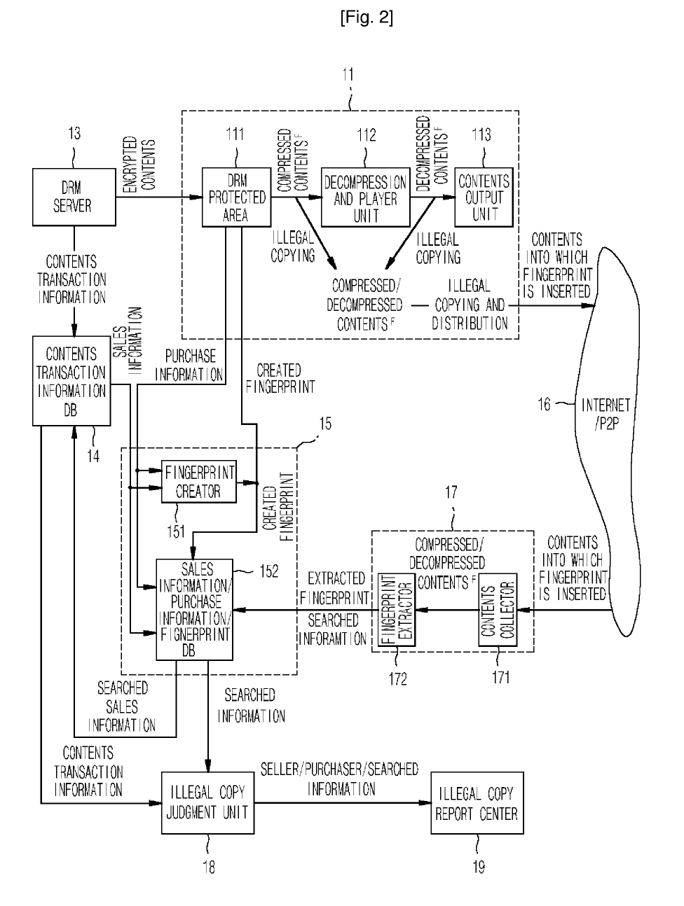

In FIG. 2, the construction of the client 11, fingerprint creator/manager 15 and contents searcher 17 among the constituent elements as illustrated in FIG. 1 is illustrated in detail.

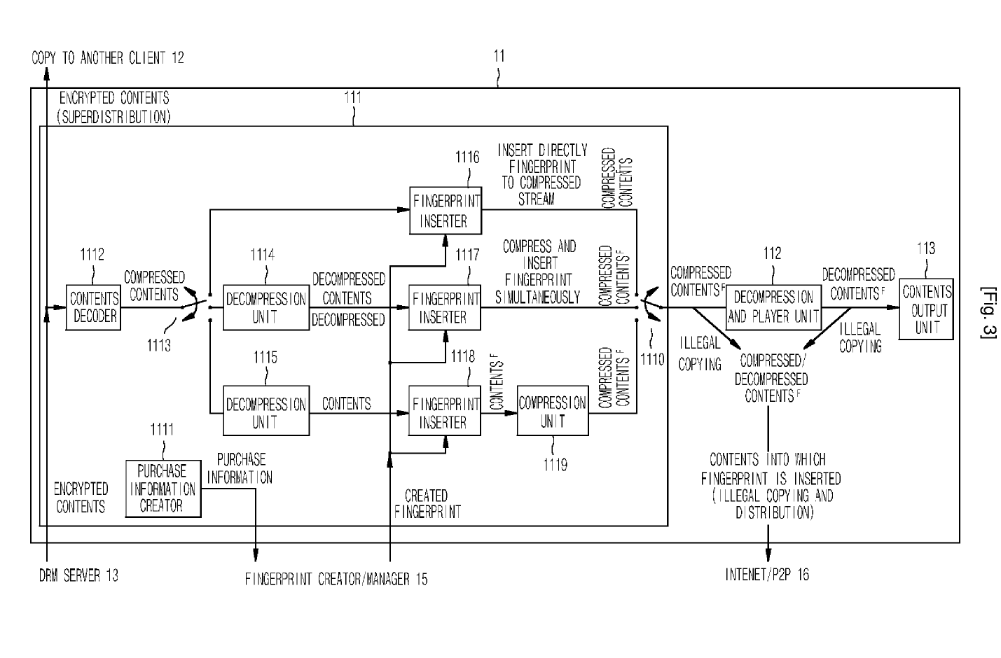

As shown in FIG. 2, the client 11 includes a DRM protected area 111, a decompression and player unit 112 and a contents output unit 113. The detailed explanation of the client will be made later with reference to FIG. 3.

The contents searcher 17 includes a contents collector 171 for collecting digital contents by acceding the Internet or P2P server, and a fingerprint extractor 172 for extracting the fingerprints from the collected contents. The contents collector 171 may collect the digital contents by accessing a certain Internet site or P2P server according to an operation method of an operator, or may search for the corresponding contents in the site or server by designating a specified name of the contents. The illegally copied contents may have a changed file name or a changed file expander that indicates the kind of the image, audio and video contents. The contents collector 171 classifies the collected contents into the image, audio and video contents by analyzing file header information irrespective of the file name or expander of the collected contents, and then sends the classified contents to the fingerprint extractor 172. That is, all the collected contents are transmitted to the fingerprint extractor 172 by image, audio and video contents, and it is checked whether the fingerprint has been inserted into the corresponding contents. If the contents having the inserted fingerprint are found, the fingerprint extractor 172 transmits the searched information such as the extracted fingerprint, contents name, position on the Internet or P2P server address from which the contents are collected, search time, etc., to the fingerprint creator/manager 15.

The fingerprint creator/manager 15 includes a fingerprint creator 151 for receiving the sales information from the contents transaction information DB 14 and the purchase information from the client 11 and creating the fingerprint, and a sales information/purchase information/fingerprint DB 152 for storing the sales information, purchase information and fingerprint. The purchase information received from the client 11 includes client's own information such as a secret key of the client 11 in order to create the fingerprint. If the extracted fingerprint and the searched information are inputted from the contents searcher 17, the sales information/purchase information/fingerprint DB 152 performs a search for the sales information and the purchase information of the inputted fingerprint. The searched sales information is transmitted to the contents transaction information DB 14, and the inputted searched information is transmitted to the illegal copy judgment unit 18.

With reference to FIG. 3, the client 11 as illustrated in FIGS. 1 and 2 will now be explained in more detail.

As shown in FIG. 3, the client 11 includes the DRM protected area 111, the decompression and player unit 112 and a contents output unit 113. The client 11 as constructed above transmits the purchase request to the DRM server 13, and receives the encrypted contents. The encrypted contents may be copied to other clients, or received from another client 11. However, in order to use the encrypted contents, the client 11 should receive a key for decrypting the code by transmitting the purchase request to the DRM server 13. In the DRM environment, this process is called a superdistribution, which is one of methods for promoting the sales of the contents. In the present invention, different fingerprints are inserted into the contents used in the client, but such a superdistribution is still possible.

In the DRM protected area 111 of the client 11, an external access cannot be performed even if the code of the contents is decrypted, and thus the contents can safely be protected. However, outside the DRM protected area 11, the decrypted contents may illegally be copied by a capture tool and x) on. That is, the decompression and player unit 112 and the contents output unit 113 refer to a DRM non-protection region, and in such a DRM non-protection region, the illegal copying of the contents can be made. In FIGS. 2 and 3, the terms “compressed contents^{F}” and “decompressed contents^{F}” indicate the contents into which the fingerprint has been inserted. This means that the illegal copying of the contents can be made only in regions except for the DRM protected area 111.

The DRM protected area 111 of the client performs the superdistribution of the contents, creation of the purchase information, decoding of the contents and insertion of the fingerprint. The purchase information creator 1111 creates and transmits information related to the contents purchase and client's own information for creating the fingerprint to the fingerprint creator/manager 15.

A contents decoder 1112 decodes the code of the encrypted contents by the key received from the DRM server 13. The decrypted contents are the same as the previous contents that were not encrypted by the DRM server 13.

Meanwhile, most digital contents stored in the DRM server 13 that is operated by a contents provider are provided in a compressed form: JPEG in the case of an image, MP3 in the case of an audio and MPEG in the case of a video. Since the compressed contents have a greatly reduced size in comparison to the general contents, most contents providers provides compressed contents in consideration of the storage capacity of a hard disk and so on and the contents transmission time. In order to use the compressed contents, a decompression unit such as a codec and an audio/video player such as Windows Media Player™, Adrenalin™, etc., should be selected according to the taste of a user.

The contents decrypted by the contents decoder 1112 pass through one of three paths according to its fingerprint insertion type, and the path is selected through a switch 1113.

If the uppermost path is selected through the switch 1113, a fingerprint inserter 1116 inserts the fingerprint directly into a stream of the compressed contents. If the intermediate path is selected through the switch 1113, a decompression unit 1114 decompresses the contents transmitted from the contents decoder 1112 and a next-stage fingerprint inserter 1117 inserts the fingerprint into the contents as it performs the compression of the contents. If the lowermost path is selected through the switch 1113, a decompression unit 1115 decompresses the contents transmitted from the contents decoder 1112, a next-stage fingerprint inserter 1118 inserts the fingerprint into the decompressed contents, and a next-stage compression unit 1119 compresses again the contents into which the fingerprint is inserted. Then, through a switch 1110 the compressed contents into which the fingerprint is inserted can be obtained. The switches 1113 and 1110 operate in synchronization with each other.

The “compressed contents^{F}” outputted through the switch 1110 means the compressed contents into which the fingerprint is inserted.

The “compressed contents^{F}” into which the fingerprint is safely inserted in the DRM protected area 111 can be used in the client to match the purchaser's taste. For example, in order to decompress the compressed contents, the decompression unit called a codec can optionally be selected according to the purchaser's taste, and also the player can properly be selected among various kinds of players such as Windows Media Player, Adrenalin, etc., according to the purchaser's taste. The compressed contents inputted to the decompression and player unit 112 and the decompressed contents inputted to the contents output unit 113 such as a monitor, a speaker, etc., exist in the DRM non-protection region. Accordingly, the present invention is characterized in that the fingerprint is safely inserted into the digital contents before the digital contents enter into the DRM non-protection region.

In the client 11 according to the present invention, the illegal copying of the contents may be made in two ways. First, the “compressed contents^{F}” may illegally be copied through a capture tool and so on before the compressed contents are inputted to the decompression and player unit 112, and in this case, the illegally copied contents become the “compressed contents^{F}”. If the contents outputted from the decompression and player unit 112 are illegally copied through the capture tool, the illegally copied contents become the “decompressed contents^{F}”. Due to the characteristic of the fingerprint, the inserted fingerprint still remains in the decompressed contents, and thus the fingerprint is found in the “decompressed contents^{F}”. Also, the fingerprint still remains even if the “decompressed contents^{F}” are compressed again. The contents illegally coped in the above-described ways are called the “compressed/decompressed contents^{F}”. If a purchaser makes a copy of the “compressed/decompressed contents^{F}” by illegally storing or re-compressing the contents through the capture tool and then distributes the copy of the contents through an Internet site or P2P server, the digital contents are distributed in a state that the fingerprint including information about the purchaser who illegally copied the digital contents has been inserted into the digital contents. Accordingly, the person who illegally copied the digital contents can be traced through the contents searcher 17 as described above.

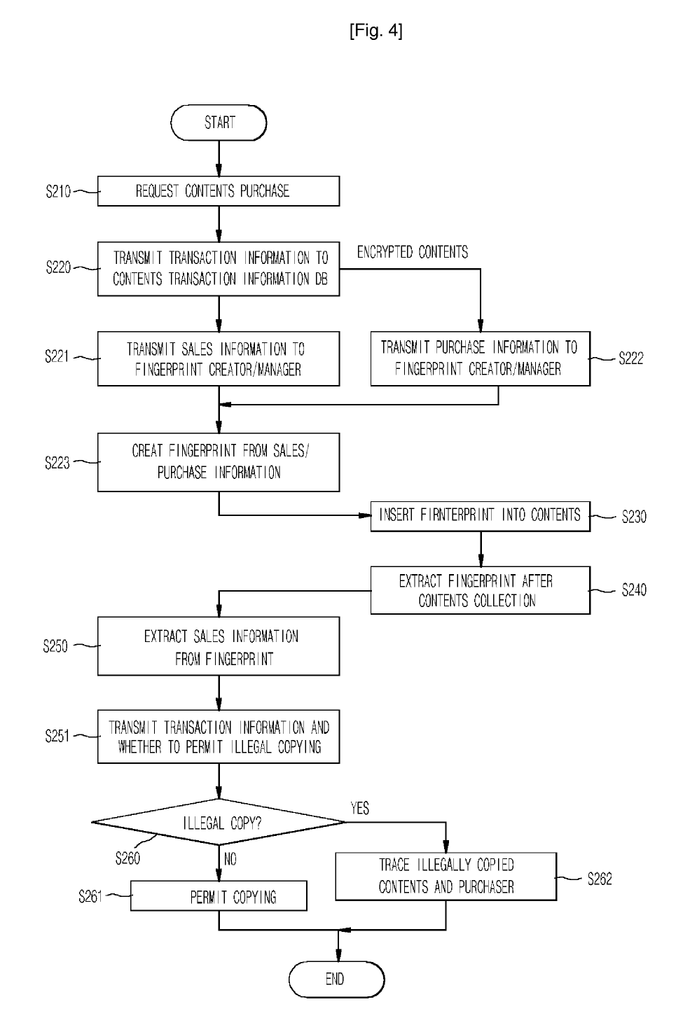

Now, with reference to FIG. 4, a method for tracing illegally copied contents on the basis of fingerprint according to an embodiment of the present invention will be explained in detail.

The clients 11 and 12 transmit a purchase request for certain digital contents to the DRM server 13 (step S210). The DRM server 13 transmits the encrypted contents to the corresponding clients in response to the purchase request from the clients 11 and 12, and simultaneously transmits the transaction information related to the sales and purchase of the contents to the contents transaction information DB 14 (step S220).

Then, the contents transaction information DB 14 stores the contents transaction information received from the DRM server 13, extracts seller's own information for creating the fingerprint from the contents transaction information as sales information, and transmits the extracted information to the fingerprint creator/manager 15 (step S221). Also, the clients 11 and 12, which have received the encrypted contents in parallel with the step S221, create and transmit the corresponding clients' own purchase information for the creation of the fingerprint to the fingerprint creator/manager 15 (step S222).

The fingerprint creator/manager 15 receives the sales information from the contents transaction information DB 14 and the purchase information from the clients 11 and 12, creates the fingerprint using the received sales information and purchase information, and transmits the created fingerprint to the client that has sent the purchase information (step S223). The client that has received the fingerprint inserts the fingerprint into the encrypted contents received from the DRM server 13 (step S230).

As described above, in the clients 11 and 12, normally purchased digital contents or digital contents superdistributed from another client may illegally be copied using a capture tool, and the digital contents illegally copied as above may be distributed through an Internet site such as a P2P server and so on.

The contents searcher 17 collects the digital contents by searching various kinds of Internet sites and P2P servers, and if the fingerprint has been inserted into the collected digital contents, it extracts the fingerprint from the corresponding digital contents (step S240). The contents searcher 17 transmits the extracted fingerprint to the fingerprint creator/manager 15, and the fingerprint creator/manager 15 extracts and transmits the sales information corresponding to the fingerprint to the contents transaction information DB 14 (step S250).

The contents transaction information DB 14 searches for the transaction information corresponding to the received sales information, and the information about the possibility of illegal copy permission of the corresponding contents, and transmits the searched information to the illegal copy judgment unit 18 (step S251).

The illegal copy judgment unit 18 receives the searched information of the corresponding contents, the transaction information and the information about the possibility of illegal copy permission, and judges whether to punish for the illegal copying (step S260). As described above, if the seller permits the illegal copying of the corresponding contents according to the seller's marketing strategy, the illegal copy judgment unit 18 takes no action against the purchaser of the corresponding contents, while if the seller judges that the punishment of the purchaser is required, the illegal copy judgment unit 18 transmits the searched information of the corresponding contents, seller and purchaser information to the illegal copy report center 19 as evidence of the illegal copying, so that the illegal copy report center 19 traces the purchaser of the illegally copied contents (step S262).

The method for tracing illegally copied contents on the basis of fingerprint according to the present invention can be implemented by a computer program, and then stored in a recording medium such as a hard disk, floppy disk, optomagnetic disk, CD-ROM, flash memory, ROM, RAM, etc.

### INDUSTRIAL APPLICABILITY

As apparent from the above description, according to the system and method for tracing illegally copied contents on the basis of fingerprint according to the present invention, the purchaser information is converted into the fingerprint and then inserted into the contents, and thus a certain user's illegal copying and distributing of the contents through Internet sites or P2P servers can be prevented. Also, in the present invention, since the insertion of the fingerprint is safely performed in a DRM protected area, the purchaser cannot access the digital contents into which the fingerprint has not been inserted through a capture tool and so on.

Also, in the event that a purchaser illegally copies and distributes the digital contents through the Internet or P2P server, it is possible to search for the illegally copied contents through a contents searcher on the basis of fingerprint and to extract the fingerprint inserted into the corresponding contents. Accordingly, even if the purchaser has changed the file name or expander of the contents, the purchaser who has illegally copied the corresponding contents can be easily searched for through tracing of the transaction information from the searched information of the corresponding contents and the extracted fingerprint. That is, according to the system and method for tracing illegally copied contents based on fingerprint according to the present invention, the illegal copying of the digital contents can be originally prevented by inserting the purchaser information of the digital contents into the digital contents in the form of a fingerprint and tracing the purchaser of the corresponding contents in the event that the digital contents have illegally been copied.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to thee skilled in the art.

1: A system for tracing illegally copied contents on the basis of fingerprint, comprising: a client for receiving encrypted contents by transmitting a purchase request for digital contents, receiving a fingerprint by providing purchase information for creating the fingerprint, and inserting the received fingerprint into the encrypted contents; a digital rights management (DRM) server tar transmitting the encrypted digital contents to the client according to the purchase request from the client and outputting transaction information related to sales and purchase of the contents, a contents transaction information database (DB) for receiving and storing the contents transaction information from the DRM server, and extracting and outputting seller's own information for creating the fingerprint torn the contents transaction information as sales information; and a fingerprint creator/manager for creating the fingerprint using the sales information received from the contents transaction information DB and the purchase information received from the client, and transmitting the created fingerprint to the client.

2: The system as claimed in claim 1, further comprising: a contents searcher for collecting the digital contents by searching various kinds of sites of Internet and peer-to-peer (P2P) servers, extracting the fingerprint from the collected digital contents if the fingerprint has been inserted into the digital contents, and outputting the extracted fingerprint to the fingerprint creator manager along with searched information of the corresponding digital contents; and an illegal copy judgment unit for receiving transaction information of illegally copied digital contents and information about a possibility of illegal copy permission, and permitting the illegal copying of the purchaser if it is judged that the seller permits the illegal copying of the corresponding contents from the received information while if not, transmitting the seller information and the purchaser information of the corresponding contents to a specified illegal copy report center as evidence of the illegal copy; wherein the fingerprint creator/manager searches for the sales information of the fingerprint using the fingerprint received from the contents searcher, transmits the searched sales information to the contents transaction information DB, and transmits the searched information of the illegally copied contents to the illegal copy judgment unit; and wherein the contents transaction information DB searches for the transaction information of the illegally copied contents from the sales information received from the fingerprint creator/manager, and transmits the information about the possibility of illegal copy permission added to the searched transaction information to the illegal copy judgment unit along with the searched transaction information.

3: The system as claimed in claim 2, wherein the information about the possibility of illegal copy permission is previously added to the contents transaction information by the seller and then stored in the contents transaction information DB.

4: The system as claimed in claim 2, wherein the contents searcher comprises: a contents collector for collecting the digital contents by accessing the Internet sites or P2P servers; and a contents searcher for extracting the fingerprint by searching whether the fingerprint is inserted into the collected digital contents, and transmitting the extracted fingerprint to the fingerprint creator/manager along with the searched information of the digital contents.

5: The system as claimed in claim 4, wherein the contents collector classifies the collected contents into image, audio and video contents by analyzing file header information irrespective of a file name or an expander of the collected contents.

6: The system as claimed in claim 1, wherein the client receives the encrypted contents from another client through superdistribution.

7: The system as claimed in claim 1, wherein the transaction information includes a seller's name, a purchaser's name, information about contents use authority, a client's Internet address from which the encrypted contents are transmitted, a date of sates and an amount of sales.

8: The system as claimed in claim 1, wherein the fingerprint creator/manager comprises: a fingerprint creator for creating the fingerprint using the sales information received from the contents transaction information DB and the purchase information received from the client; and a sales information/purchase information/fingerprint DB for storing the sales information, the purchase information and the created fingerprint.

9: The system as claimed in claim 1, wherein the client comprises: a DRM protected area for performing a superdistribution of the encrypted contents, a creation of the purchase information, a decoding of the encrypted contents and an insertion of the fingerprint; a decompression and player unit for receiving the contents into which the fingerprint has been inserted from the DRM protected area, decompressing the contents, and playing the decompressed contents; and a contents output unit for visually and aurally outputting the decompressed contents being played by the decompression and player unit.

10: The system as claimed in claim 9, wherein the DRM protected area comprises: a purchase information creator for creating and transmitting information related to the contents purchase and client's own information for creating the fingerprint to the fingerprint creator/manager; a contents decoder for decoding a code of the encrypted contents by a key received from the DRM server; a multiplexer for selecting one of three paths that are divided according to a fingerprint insertion type, and outputting the digital contents decoded by the contents decoder through the selected path; a fingerprint insertion means composed of a first path for directly inserting the fingerprint into a stream of the compressed digital contents transmitted through the multiplexer, a second path for decompressing the compressed digital contents transmitted from the multiplexer and compressing the digital contents as inserting the fingerprint into the decompressed digital contents, and a third path for decompressing the compressed digital contents transmitted from the multiplexer, inserting the fingerprint into the decompressed digital contents, and then compressing the digital contents into which the fingerprint has been inserted; and a demultiplexer for selecting one of the three paths of the fingerprint insertion means, and outputting the digital contents into which the fingerprint has been inserted through the selected path.

11: A method for tracing illegally copied contents on the basis of fingerprint, comprises the steps of:
(a) encrypting digital contents and transmitting the encrypted digital contents to a client according to a contents purchase request of the client, and storing
transaction information related to sales and purchase of the contents in a seller's database (DB);
(b) receiving transaction information of the sold digital contents and client's own purchase information, and creating the fingerprint;
(c) transmitting the fingerprint created at the step (b) to the client to insert the fingerprint into the sold digital contents;
(d) collecting the digital contents by searching various kinds of sites of Internet and peer-to-peer (P2P) servers, and extracting the fingerprint from the collected digital contents it the fingerprint has been inserted into the digital contents;
(e) searching for transaction information corresponding to the fingerprint extracted at the step (d) from the seller's DB, and searching for information about a possibility of illegal copy permission; and
(f) judging whether to punish for the illegal copying on the basis of the transaction information searched at the step (e) and the information about the possibility of illegal copy permission and if a punishment is necessary, transmitting the searched information of the illegally copied contents and the transaction information to a specified administrative organ.

12: The system as claimed in claim 2, wherein the client receives the encrypted contents from another client through superdistribution.

13: The system as claimed in claim 2, wherein the transaction information includes a seller's name, a purchaser's name, information about contents use authority, a client's Internet address from which the encrypted contents are transmitted, a date of sales and an amount of sales.

14: The system as claimed in claim 2, wherein the fingerprint creator/manager comprises: a fingerprint creator for creating the fingerprint using the sales information received from the contents transaction information DB and the purchase information received from the client; and a sales information/purchase information/fingerprint DB for storing the sales information, the purchase information and the created fingerprint.

15: The system as claimed in claim 2, wherein the client comprises: a DRM protected area for performing a superdistribution of the encrypted contents, a creation of the purchase information, a decoding of the encrypted contents and an insertion of the fingerprint; a decompression and player unit for receiving the contents into which the fingerprint has been inserted from the DRM protected area, decompressing the contents, and playing the decompressed contents; and a contents output unit for visually and aurally outputting the decompressed contents being played by the decompression and prayer unit.

16: The system as claimed in claim 15, wherein the DRM protected area comprises: a purchase information creator for creating and transmitting information related to the contents purchase and client's own information for creating the fingerprint to the fingerprint creator/manager; a contents decoder for decoding a code of the encrypted contents by a key received from the DRM server; a multiplexer for selecting one of three paths that are divided according to a fingerprint insertion type, and outputting the digital contents decoded by the contents decoder through the selected path; a fingerprint insertion means composed of a first path for directly inserting the fingerprint into a stream of the compressed digital contents transmitted through the multiplexer, a second path for decompressing the compressed digital contents transmitted from the multiplexer and compressing the digital contents as inserting the fingerprint into the decompressed digital contents, and a third path for decompressing the compressed digital contents transmitted from the multiplexer, inserting the fingerprint into the decompressed digital contents, and then compressing the digital contents into which the fingerprint has been inserted; and a demultiplexer for selecting one of the three paths of the fingerprint insertion means, and outputting the digital contents into which the fingerprint has been inserted through the selected path.
